(19) United States
(12) Patent Application Publication
(10) Pub. No.: US 2012/0199509 A1
(43) Pub. Date: Aug. 9, 2012

(54) Pharmaceutical package

(76) Inventors: Frank Albert McKiel, JR., Colorado Springs, CO (US); Margaret Elizabeth Sweeney-McKiel, Albuquerque, NM (US)

(21) Appl. No.: 13/374,536

(22) Filed: Dec. 31, 2011

Related U.S. Application Data
(60) Provisional application No. 61/460,540, filed on Jan. 3, 2011.

(51) Int. Cl. A61J 1/03; B65D 85/00; B65D 73/00

(52) U.S. Cl. 206/459.1; 206/467

(57) ABSTRACT

A packaging for pharmaceutical pills or the like is disclosed having formed therein both a payload enclosure and a recessed activating feature. The recessed activating feature, once activated using a pointed object, changes the packaging into a form that may be more readily opened by hand.

### RELATED APPLICATIONS

This patent application is related to, and claims the benefit under 35 U.S.C. 119(e) of, U.S. Provisional Patent Application No. 61/460,540, filed Jan. 3, 2011, the content of which is hereby incorporated by reference in its entirety as if fully set forth herein.

### TECHNICAL FIELD OF THE INVENTION

The present invention relates to pharmaceutical packaging and, more particularly, to a form of packaging that secures and protects its contents yet is readily opened under specific circumstances.

### BACKGROUND OF THE INVENTION

Drugs delivered in the form of pills or capsules are well known in the pharmaceutical industry. These are often packaged in so-called ‘blister packs’ wherein an array of cavities or wells are formed in a first sheet of plastic or cellulose using blow molding or vacuum forming, a single pill is placed within each cavity, and then a second flat layer of paper, metal foil or plastic is bonded to the first layer to effectively seal the cavities. The resulting panels typically have many pill-bearing cavities and may be provided to the end consumer in this form or may be separated into smaller or individual packs before reaching the consumer or health care professional who will administer the drugs. This type of packaging is often imprinted with information identifying the drug, dosage, lot number, expiration date and/or instructions for opening the packaging. These panels also may be scored or perforated to facilitate breaking the sheet into smaller pieces carrying a smaller number of pills than the original sheet. For example, some consumers may prefer to carry only one or two pills in their pocket or purse while leaving the remainder of the ‘card’, perhaps along with the box having more extensive instructions or prescription information on it, in a medicine cabinet or the like.

This type of packaging for pills and capsules, while easy to manufacture, has many shortcomings with respect to ease of use. Many of these implementations result in a tightly sealed cavity wherein the contents are surrounded by such thick plastic and foil that they are hard to open. The manner of bonding the layers together to seal the packaging creates a perimeter seal where the two layers are difficult to separate, especially if scissors are used to cut around a cavity to separate out a single pill. Some implementations require the end user to use a pair of scissors to carefully cut the packaging just close enough to the pill-containing well to cut through a section where the two layers are not bonded, yet not so close as to damage the pill itself. Many people ignore this procedure and simply break into the cavity from the foil side using scissors or pointed objects such as pencils, paper clips, etc. This unfortunately risks contaminating and damaging the pill as well as physical injury to the hand holding the packaging.

Naturally, there is a desire to secure and protect the contents from contamination and degradation from exposure to moisture and oxygen. A strong container is also desirable to prevent opening of the container too easily, such as through casual contact with other items in one's pocket or purse or if the packaged drug inadvertently comes into the reach of a small child. This bodes in favor of very strong packaging, but that tends toward packaging that is difficult to open when access to the drug contents is needed. Accordingly, it is difficult to design the material strength of a package to be sufficiently easy to open when desired and yet resistant to opening under undesirable circumstances.

Some packages of this type for example use relatively thin paper or foil for the second layer such that, by applying pressure on top of the cavity to collapse it, the pill can simply be pushed through the second layer. The pill is placed under considerable localized force as it becomes the blunt object that penetrates the paper or foil membrane. Some users employ a fingernail or other object to penetrate the foil from the foil side, opening up the cavity from the foil side and then pealing back the foil to open the cavity or otherwise coaxing the pill out of the cavity by forcing it past the foil.

Features of packaging, especially after being separated from a multi-pill card into a single unit package, can be very small, complicating the use of the product by anyone with poor eyesight or manual dexterity. This compounds the problem and effectively discourages some consumers from adhering to their necessary or scheduled dosing.

One approach known in the prior art is described in U.S. Pat. No. 3,921,805 to Compere. The '805 patent describes a laminated structure having a weakened slit. By this feature, the package taught by Compere may be opened by bending the package to break the upper laminate layer and permit separation of layers that form the pill containing cavity. Another approach is described in U.S. Pat. No. 4,294,361 to Margulies et al. wherein an upper layer of a laminar package is split along a weakened line by pressing upon a bubble-shaped feature in a lower layer.

What is needed beyond these and other prior art approaches is a form of packaging for pills that more strongly secures and protects the contents and yet is easily opened when needed without unnecessary risks to the contents or the end user.

### SUMMARY OF THE INVENTION

The present invention achieves the foregoing characteristics by providing an opening feature, separated from the pill-containing cavity, that can be activated using readily available implements and that, when activated, yields a subsequent configuration of the packaging that is much easier for a user to hold and open.

### BRIEF DESCRIPTION OF THE DRAWINGS

To those of ordinary skill in the relevant art, the present invention will be readily understood by reference to the detailed description below, describing one or more exemplary embodiments, when taken in conjunction with the associated drawings in which:

FIG. 1 is a pictorial view of a packaging unit in accordance with an embodiment of the present invention;

FIG. 2 depicts a cross-section of a package of the type shown on FIG. 1;

FIG. 3 depicts the formation and stacking of layers to form a package;

FIG. 4 shows a first intermediate form of a lower packaging layer in accordance with a manufacturing approach according to the present teachings;

FIG. 5 shows a second intermediate form of a lower packaging layer layer in accordance with a manufacturing approach according to the present teachings;

FIG. 6 depicts a cross-section of the lower layer as was shown in FIG. 5;

FIGS. 7A-7D depicts in cross-section the manner in which a stylus object engages a recessed lip formed in a lower layer and prepares the package to be opened;

FIG. 8 depicts a manner in which a user's hands may grasp and open a package of the type taught herein;

FIG. 9 shows an overview of a ‘card’ in which is formed multiple packaging units of the type taught herein;

FIG. 10 shows a package in which additional features are formed such that pairs of packaging units may engage and removably interlock in a back-to-back fashion;

FIG. 11 depicts in cross-section the interlocking action of two package units which have been formed as in FIG. 10; and

FIGS. 12A-12B show various arrangements of multiple packaging units wherein the opening of one unit renders an adjacent unit available to be subsequently opened.

### DETAILED DESCRIPTION OF THE INVENTION

The principles of the present invention, as well as further features and advantages, will be understood by those of ordinary skill in the art by referring to the following description, taken in conjunction with the accompanying drawings, describing various exemplary embodiments.

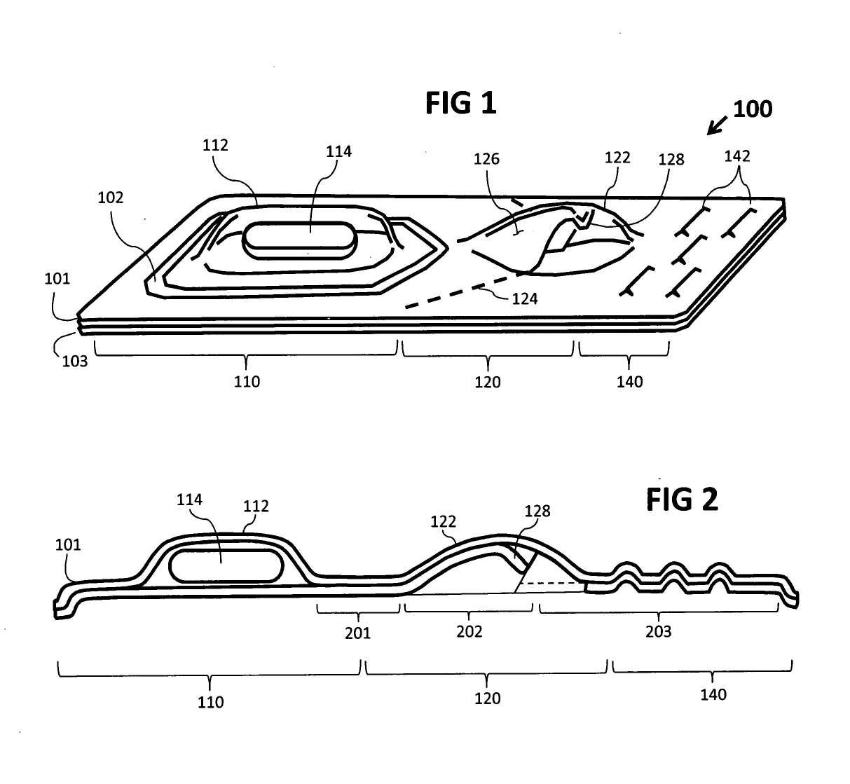

FIG. 1 depicts a pictorial view of a package formed in accordance with an exemplary embodiment of the present invention. The pill package 100 is shown to comprise three sections, namely a payload cavity portion 110, an opening trigger portion 120 and an optional extended grip portion 140.

The pill or capsule payload 114 is housed in a bubble-shaped well or cavity 112 formed in an upper layer made of, for example, clear plastic. The upper layer 101 is bonded to a bottom layer 103 to complete the enclosure and sealing of the cavity with the contents inside. (The distinct upper and lower layers and the respective features of each are more clearly depicted in other figures herein.) The layers may be bonded over a large area, essentially wherever they run flat and parallel with one another in the vicinity of the cavity 112. Alternatively, specific areas of bonding between the layers, as depicted by bond line 102, may be used in a specific pattern surrounding the pill cavity. This may be accomplished by localized thermal or ultrasonic welding between the layers or by an intervening adhesive or the like. In the context of the present invention, a shaped bond area 102 is contemplated to be advantageous for ensuring that the peeling action to be described later works reliably to open the cavity when needed.

As further shown in FIG. 1, an opening trigger portion 120 is formed as a second cavity or well 122 wherein both layers of the package 100 are bulged upward to form a common cavity. As will be described below, the bottom layer partially conforms to this concave shape but is also partially cut away and provided with a lip to allow for prying the bottom layer away from the top layer. The recess of this bottom layer feature within the concave well 122 lends to the ability of this embodiment to resist inadvertent opening of the container. When opened by a user, the domed portion of the lower layer will invert its curvature and essentially ‘pop outward’ to protrude from the bottom of the package. The user may then use fingertips to snag the tab protruding from the lower layer and peel it apart from the upper layer.

The extended grip portion 140 is an optional feature wherein the package is extended and the material of the package is provided with bumps, ridges or texturing to facilitate gripping with fingers while opening the package.

Perforations 124 or score marks in the lower layer are shown in FIG. 1 so that the action of pulling the inverted tab from the lower layer propagates the separation between the upper and lower layers to spread across the width of the package, or at least wide enough to ensure that the pill-containing well 112 is sufficiently opened by this action.

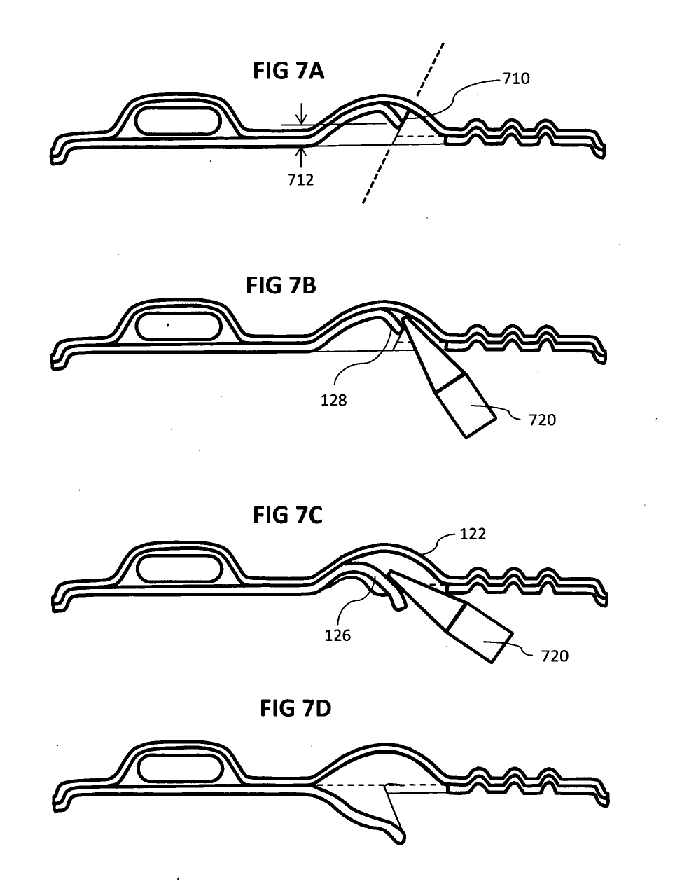

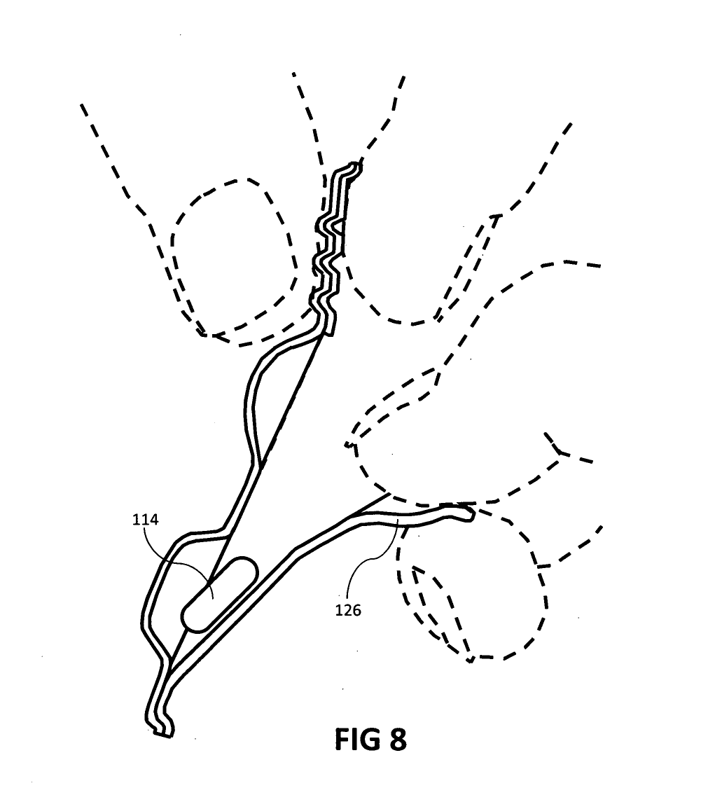

FIG. 2 depicts a cross-section of package 100 more clearly showing top layer 101 and bottom layer 103. Within cavity 122, it is evident how bottom layer 103 conforms to the curvature formed in top layer 101. The degree of conformance may be controlled as desired to influence the difficulty of opening and the likelihood of inadvertent opening or incidental ‘snagging’ on foreign objects and such. Even a flat bottom layer having a cutaway portion could require a pointed object to force open the package. An advantage to having the layers conform is that the bottom layer, when inverted, provides an additional handle-like feature as will be shown in FIG. 7D and FIG. 8. Over the areas where top layer 102 and bottom layer 103 are in close proximity, the layers may be selectively bonded or adhered in some regions. In other regions, the layers may be in contact but not positively bonded. The pattern of bonding may be controlled at the time of manufacture, such as by a patterned application of an interstitial adhesive or by selectively applying heat, pressure or ultrasonic energy using formed tooling as is generally well known in the art.

For example, in FIG. 2, portion 201 may be an area where the layers are bonded, perhaps as part of bond line 102 shown earlier. Along portion 202, the layers are preferably left unbonded in support of the operating principles of the present invention. As described later, this portion of the lower layer is expected to easily separate from the top layer, being held in place normally by forces other than adhesion to the top layer. Like portion 201, portion 203 is yet another area along which the upper and lower layers are preferably permanently bonded. Also depicted in FIG. 2 is a cut area where a portion of lower layer is removed or formed with an appropriately shaped opening. Lip 128 is evident in cross-section and serves as one form of stylus-engaging edge. As explained further below, a pointed object or stylus may be inserted into cavity 122 from underneath and used to engage this portion of the lower layer to initiate opening of the package.

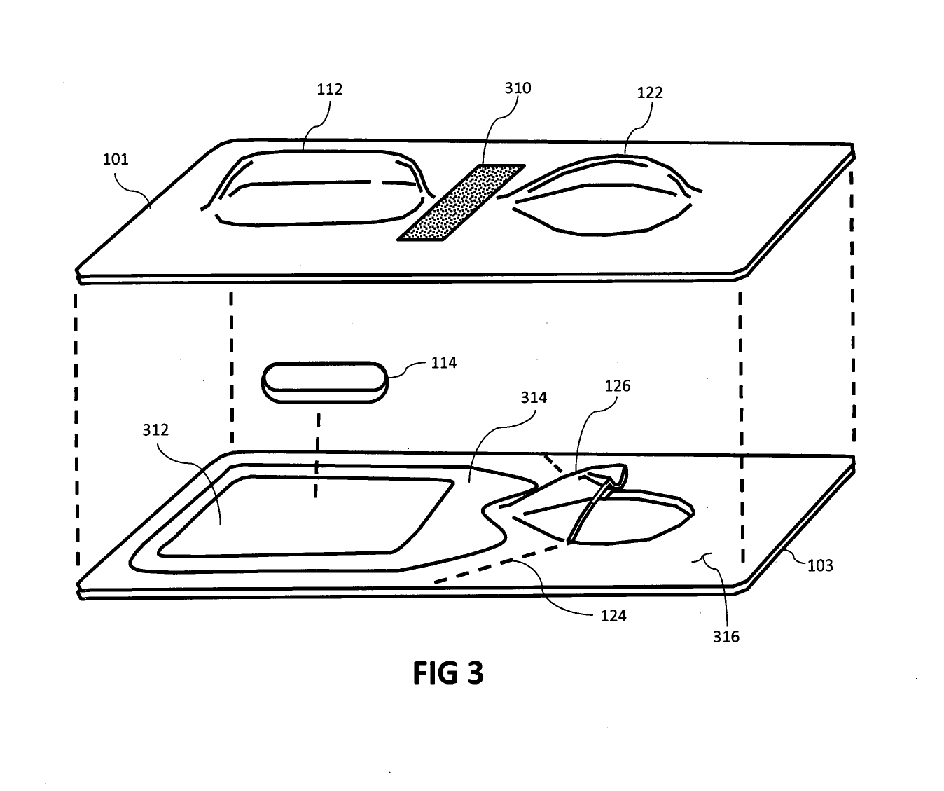

FIG. 3 depicts an exemplary manner of assembling top layer 101 and bottom layer 103 to form a completed package in accordance with an embodiment of the present invention. Using vacuum molding, blow molding, injection molding or the like, top layer 101 is formed to comprise bubbled or domed portions 112 and 122, which were also shown in previous figures. A printed portion 310 is also shown on layer 101 as part of a tamper-evident mechanism as will be described further below. The tooling to achieve this shape is well within the understanding of those skilled in the forming of plastics.

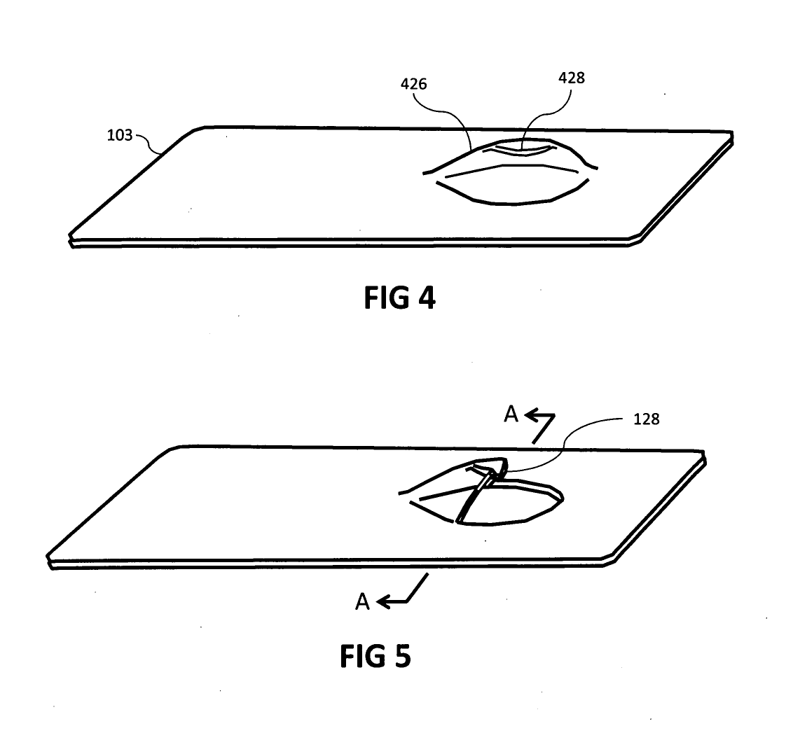

The mating bottom layer 103 is shown to comprise invertible partial dome 126 designed to conform to the inside of dome 122 in top layer 101. One manner of forming this layer prior to assembly with layer 101 will be described in connection with FIGS. 4-6. Perforations 124 are also evident in layer 103.

On bottom layer 103, a bond area 314 is depicted as surrounding the payload lid area 312. Bond area 103 represents a pattern where adhesive may be applied or, using appropriately shaped tooling, a plastic weld may be accomplished between the top and bottom layers. Once the two layers are joined, payload capsule 114 will be sealed from the outside atmosphere by the bond along area 314. Surface region 312 of the bottom layer 103 is not bonded to top layer 101 and, in conjunction with well 112, serves as one wall of the payload compartment. Region 316 shown is preferably on one side of perforation 124 is preferably bonded to top layer 101.

To implement a tamper-evident feature, area 314, or a portion thereof may also represent a pattern of printing or coloring applied to bottom layer 103 such that it will show through layer 101 once the layers are bonded together. Printed portion 310 may operate in conjunction with printing in area 314 based on the following principle. Many forms of bonds between plastic surfaces, both with or without adhesive, exhibit an optical effect of being transparent when the bond is originally formed, yet translucent or ‘frosted’ in appearance once the bonded surfaces have been initially separated. It is therefore contemplated to imprint the lower layer with a coloring and to imprint the top layer with a similarly colored indicia, such as the letter “X”, a pattern of dots or the word “OPEN”. When the seal is initially formed during manufacture, the transparency of the bond between the layers will cause, for example, a red-colored word “OPEN printed on the top layer to be superimposed above a red background showing through from the bottom layer. The net effect is that the word “OPEN” will not be contrasted with the background and will thus not be apparent to an end user. However, once the seal has been broken by forceful separation of layer 101 from 103, the bond layer will become irreversibly translucent and appear to be essentially white. In this case, the printed word “OPEN” will appear as red letters on a white background while the red printing from the bottom layer will barely show through, if at all.

In an alternative embodiment, the top layer and bottom layers may be imprinted with contrasting colors, such as red and deep blue, respectively. In this scheme, the overlapping red and blue colors coupled through an undisturbed, transparent bond result in a very dark, poorly contrasting image. The combination of red over blue filters out most visible light and results in very little reflected light. After the bond has been destroyed and rendered translucent, the red appears very prominently.

The capsule payload 114 is captured between layers 101 and 103 just before the layers are bonded together. It is contemplated that capsule payload 114 may simply be dropped into well 112 of layer 101, inverted compared to FIG. 3, and held there by gravity as layer 103 is placed on top and sealed. During manufacture, the same tooling used to form wells 112, 122 in top layer 101 may be used to support the package as the pill is inserted into the well and may also serve as tooling for sealing the layers together.

FIG. 4 depicts one stage in the formation of bottom layer 103 in accordance with an exemplary embodiment. A domed region 426 is formed in a sheet of plastic or the like using vacuum molding, blow molding, etc. On top of domed region 426 is shown a small inversion 428 of the dome. This ‘bump within a dome’ shape is easily formed using an appropriately shaped mold.

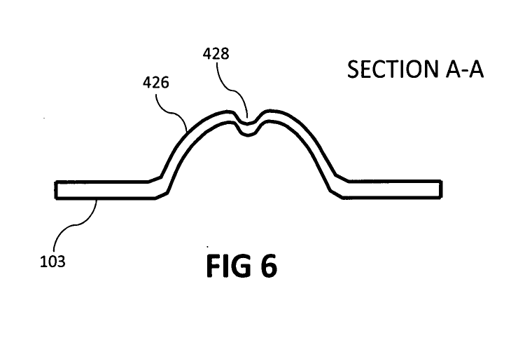

FIG. 5 depicts a subsequent stage of formation wherein part of the domed region 426 of the bottom layer 103 has been cut away. This may be accomplished using a die cutter or a laser. Note that the angle of the cut is preferably tilted such that the resulting lip 128 protrudes. This angle improves the ability of a user's fingertip to engage the invertible dome portion once it has been popped out away from the top layer. This action will be more evident in later figures. FIG. 5 also shows the designation of a section A-A, the view of which is shown in FIG. 6. FIG. 6 shows this cross-sectional view of the bottom layer. In FIG. 6, it is apparent how the domed region 426 is shaped and how the small inversion 428 is inset along the top of the dome. It is this bump that forms the lip 128 in the finished product.

FIGS. 7A-7D demonstrate operation of the features of the presently described packaging in preparation for accessing the contents. For reference, FIG. 7A shows a cross-section of a package having been completely manufactured and ready for use. The cut edge 710 shows the angled cutaway of the lower layer. FIG. 7A also shows a recess depth 712 corresponding to the depth by which an opening feature, such as lip 128, is displaced inward away from the bottom surface of the package. In accordance with the present teachings, this degree of inset is at least the thickness of the lower layer (for example, in the case where portion 202 of the bottom layer remains flat rather than conforming to upper layer cavity 122) but may be even further inset as shown in FIGS. 2, 5, 6 and 7 to make inadvertent opening even less likely. FIG. 7B shows the insertion of an object 720 that is sufficiently small and pointed to reach into domed portion 122 and slip between lip 128 and top layer 101. Cut edge 710, and particularly lip 128, serve as a stylus-engaging edge formed in lower layer 103. The recessing of the lip 128 inside the concavity of dome 122 is an important feature to ensure that the package remains secure until intentionally opened. The opening feature is unlikely to be reached by casual contact with other items or to be easily contacted by the fingernails or fingertips of even small children. However, anytime the enclosed pill is to be legitimately accessed, any form of readily available small stylus, such as a pencil tip, paper clip, toothpick, fork tine or the like, is able to engage the lip 128 and prize out the invertible dome portion 126 of the bottom layer 103. Note that dome 122 may be shaped other than just hemispherically so as to guide a pointed object into engagement with the lip 128. The rightmost portion of the dome may form a channel or funnel of sorts to guide an object 720 toward lip 128.

FIG. 7C shows an intermediate stage of inverting the bottom layer using the stylus object.

FIG. 7D shows a package after the stylus object 720 has been used to completely invert the invertible dome portion of the bottom layer 103. The angle cut 710 has resulted in a ‘scoop’ shape that readily catches upon a fingertip. As the top and bottom layers are pulled apart to open the package, the angled cut 720 also facilitates the propagation of separation line along the perforations 124 in the bottom layer.

FIG. 8 is a cross-section and pictorial representation of a user's fingers grasping and peeling open the package as was prepared for opening in FIG. 7D. The inverting of the invertible dome portion of the bottom layer provides a tab that protrudes considerably away from the remainder of the package and is easy to find by feel. Once a user's finger or thumb gets behind the inverted dome portion, the user is able to grasp and/or pry behind this feature to separate the layers as shown. Ample grip and leverage is provided to enable the end user to break the sealing bonds (described earlier) and separate the layers to free the capsule 114.

It should be noted that one or both layers 101 and 103 may be provided with additional stiffening or crush-resistant features, such as a creased rim around the perimeter. As the present invention does not require flexure of the package to open it, the packaging may be made much more robust to protect the contents yet still be readily opened when needed.

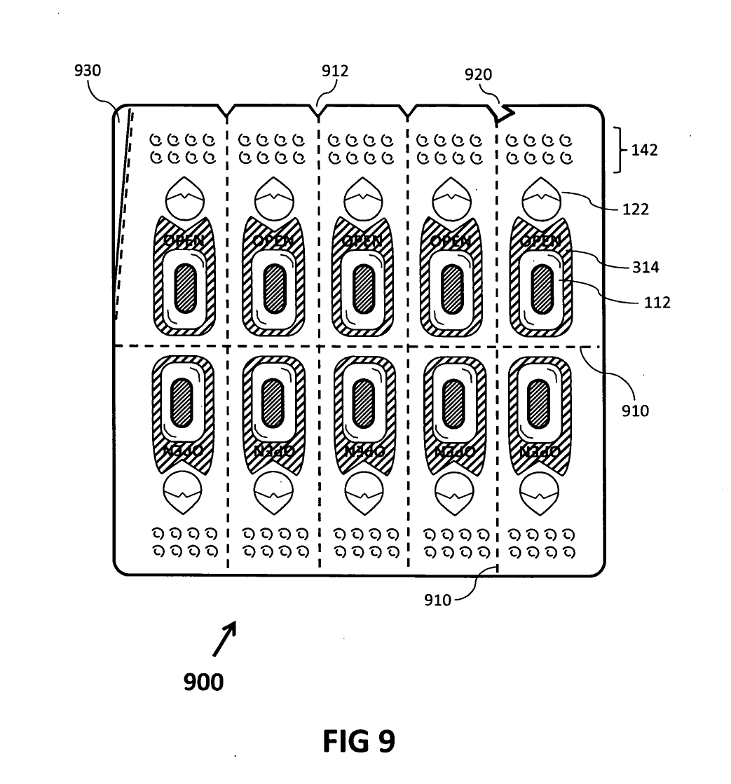

FIG. 9 depicts a typical manner in which multiple units as described thus far may be formed within a single ‘card’ or blister pack. Card 900 is shown by example to comprise ten pill-carrying units, though the number and arrangement may certainly be varied. Card 900 is shown to have optional perforations 910 allowing an end user to separate the units. Perforations 910 preferably penetrate through both layers (101 and 103 introduced earlier) of the package. Another optional feature are notches 912 to further facilitate separation of the units, if desired.

In accordance with an exemplary embodiment, at least one of the units is optionally equipped with an integral stylus feature 920 that, once detached, allows one unit to be useful as a tool for reaching into the dome 122 of another packaging unit. Alternatively or additionally to ensure availability of an opening tool when the card is obtained, a separable stylus 930 may also be provided as part of the card, perhaps formed as a shaped ridge by the same mold that forms the blisters in the card and made removable by a perforation. It is contemplated that multiple ones of these tools might be formed in a single card and that these could be interstitiated between the payload-carrying units.

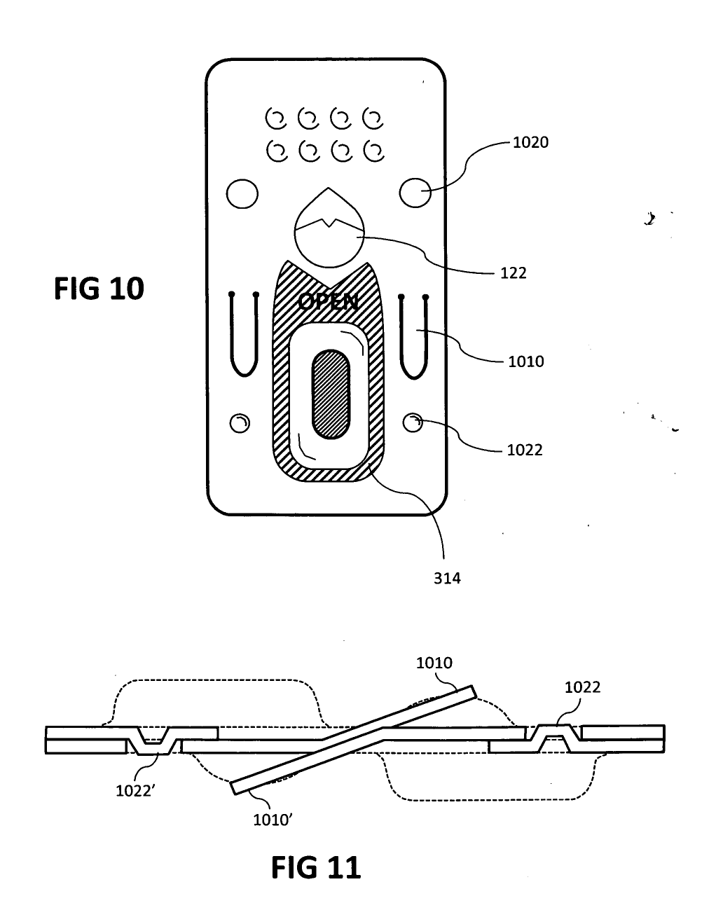

FIG. 10 depicts an additional optional feature for coupling two or more packaging units ‘back-to-back’ so that they may be conveniently carried together and may supplementally protect each other's opening feature from encroachment by foreign objects. As shown, each unit is equipped with a pair of patterned cuts that each form a tongue or flap 1010. Each unit also preferably equipped with a pair of small downward bumps 1022 and a pair of holes or upward bumps 1020 large enough to accommodate the smaller bumps 1022.

FIG. 11 depicts, in cross-section, how two units equipped as in FIG. 10 may be coupled together back-to-back by sliding the flaps 1010 of one unit into the flap openings of the other unit. Done properly, the smaller bumps 1022 on each unit nest into the larger holes or bumps 1020 in the other unit, effectively locking the units together. The units thus coupled are fairly easy to snap apart by hand but may be resistant to coming loose simply by random contact with other items such as in a clothing pocket or purse.

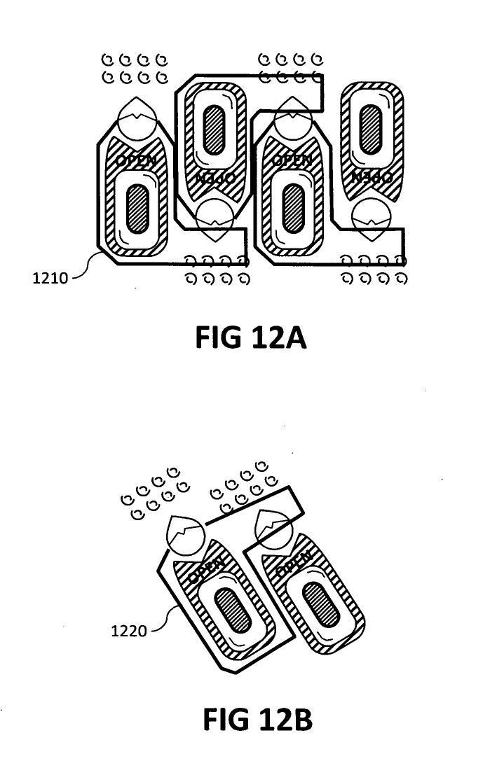

FIG. 12A depicts a pattern 1210 for perforating a bottom layer such that opening a first unit in the manner as described herein also acts to uncover the opening feature of an adjacent unit. This effect may be cascaded so that each unit opened for accessing its contents also makes the next unit available to be opened. This approach may be used to enforce a sequence in opening of the units which, in turn, may be used to control the rate of opening the units or to ensure that the pills inside are taken in a particular sequence. The latter may be useful for tapering or alternating dosages or for ensuring alternation between different drugs where needed in a given therapy.

FIG. 12B depicts an alternative way of organizing packaging units and providing an alternative perforation pattern 1220 such that a second unit on the right cannot be opened until the left unit is first opened.

While the present invention has been shown and described by way of the foregoing example embodiments, these descriptions should be construed as limiting the scope of the present invention. Those of ordinary skill in the art will recognize that many variations are possible in such aspects as the shape and form of the finished product, choice of materials, manufacturing steps, etc. while adhering to the spirit of the invention as expressed in the claims that follow below.

What is claimed is:

1. A package for containing an item, comprising:
a first layer of material; and
a second layer of material bonded to the first layer along at least one bond region;
wherein at least one of the first and second layers includes a first bubble formed away from the respective other layer to form a first payload cavity for containing the item;
wherein the first layer comprises a second bubble separate from the first payload cavity and the second layer comprises a curved feature that curves towards the second bubble and substantially conforms to an inside surface of the second bubble and the curved feature includes a stylus-engaging edge.

2. The package of claim 1 further comprising:
indicia printed on both the first and second layers, positioned to correspond with the bond region, wherein the transparency of the bond region changes upon separation of the first and second layers causing the indicia to change in appearance indicating that the package has been opened.
